(19) United States
(12) Patent Application Publication
(10) Pub. No.: US 2026/0318075 A1
(43) Pub. Date: Oct. 15, 2026

(54) SLIP RESISTANT SUBSTRATE

(71) Applicant: Arclin USA LLC, Alpharetta, GA (US)

(72) Inventors: Howard M. Morris, Upholland (GB); Adam Morris, Warrington (GB)

(73) Assignee: Arclin USA LLC, Alpharetta, GA (US)

(21) Appl. No.: 19/324,232

(22) Filed: Sep. 10, 2025

Related U.S. Application Data
(60) Provisional application No. 63/694,455, filed on Sep. 13, 2024.

(51) Int. Cl. E04C 2/12; C09D 5/28; C09D 15/00; E04C 2/52

(52) U.S. Cl. CPC E04C 2/12; C09D 5/28; C09D 15/00; E04C 2/52

(57) ABSTRACT

A method of preparing a slip resistant surface is provided. The method includes applying a viscous composition to a surface of a substrate, forming a surface pattern comprising a plurality of protrusions within the opposing surface and solidifying the layer of viscous composition to (i) provide the slip resistant surface from the surface pattern and (ii) bond the adhering surface to the surface of the substrate. A slip resistant substrate is also provided.

### CROSS-REFERENCE TO RELATED APPLICATIONS

This application claims priority to and benefit of U.S. Provisional Patent Application No. 63/694,455, filed on Sep. 13, 2024, which is incorporated by reference in its entirety.

### FIELD OF THE INVENTION

The present invention relates to slip resistant substrates, such as slip resistant construction panels, and methods of preparing the same.

### BACKGROUND OF THE INVENTION

It is known to manufacture various substrates, such as constructional panels, to include a slip resistant surface. This is especially common when producing a flooring substrate that is designed to reduce the risk of, or prevent, a person from slipping when walking on the flooring substrate. Increased slipping potential on flooring substrates is particularly problematic when such substrates are located in areas that are exposed to wet weather conditions, for example outdoor building sites.

Certain slip resistant substrates, such as wood-based slip resistant flooring panels, are typically formed by coating a substrate surface with an anti-slip coating composition which contains an anti-slip aggregate material. Once the anti-slip coating composition is fixed or adhered to the substrate surface, the aggregate material provides the substrate surface with slip resistant properties. There are several issues associated with the use of these anti-slip coating compositions on substrates. These include difficulties in controlling the level of slip resistance on the finished substrate, the high costs associated with manufacturing, purchasing and processing of anti-slip coating compositions and the risk of aggregate material detaching and becoming loose from the substrate during use which can lead to a loss in slip resistance. In addition, certain aggregate materials cause the surface of the finished substrate to have an undesirable appearance and texture.

It is an object of the present invention to obviate or mitigate at least one or more of the above-mentioned disadvantages.

It is for instance desirable to provide a method of preparing a substrate comprising a slip resistant surface which does not involve the use of anti-slip coating compositions containing anti-slip aggregate material and also that results in a substrate surface having an aesthetically improved appearance and texture.

### SUMMARY OF THE INVENTION

In general, the present invention proposes a unique method of preparing a slip resistant substrate comprising a slip resistant surface. The method involves treating a surface of a substrate to create a layer of viscous composition on the surface of the substrate. The layer of viscous composition has an adhering surface which is in contact with the surface of the substrate and an opposing surface that is facing away from the surface of the substrate. The method involves the step of forming a surface pattern comprising a plurality of protrusions within the opposing surface before then solidifying the layer of viscous composition to (i) provide the slip resistant surface from the surface pattern and (ii) bond the adhering surface to the surface of the substrate. Advantageously, it has been found that a substrate, in particular a constructional panel (e.g. flooring panel), manufactured according to the method of the present invention can be easily and cost-efficiently processed to have slip resistant properties. Unlike conventional methods used to prepare slip resistance substrate surfaces, which typically adopt expensive and difficult to use anti-slip coating compositions containing aggregate materials, the present invention provides a method of preparing a substrate without the need to use such anti-slip coating compositions. The present invention generally involves the coating of a substrate surface with a suitably viscous composition to provide a layer of viscous composition on the surface of the substrate before then creating a surface pattern within the layer of viscous composition. The surface pattern is integrally formed within the layer of the viscous composition and includes a plurality of protrusions which project out of the plane of the layer of viscous composition and away from the substrate surface. Once the viscous composition is solidified, the surface pattern provides a slip resistant surface which is integrally formed within the layer of the viscous composition to provide the slip resistant substrate. By virtue of creating a slip resistant surface pattern which is integrally formed within the layer of viscous composition located on the substrate the need to use undesirable slip resistant additive materials (e.g. aggregate material) can be obviated. This is leads to process efficiencies, reduced material costs and an environmental benefit.

In some embodiments, a method of preparing a substrate comprising a slip resistant surface, the method can include applying a viscous composition to a surface of a substrate to form a layer of viscous composition on the surface of the substrate, wherein the layer of viscous composition has an adhering surface which is in contact with the surface of the substrate and an opposing surface facing away from the surface of the substrate; forming a surface pattern comprising a plurality of protrusions within the opposing surface; and solidifying the layer of viscous composition to (i) provide the slip resistant surface from the surface pattern; and (ii) bond the adhering surface to the surface of the substrate.

In a first aspect of the present invention there is provided a method of preparing a substrate comprising a slip resistant surface, the method comprising the steps of (a) applying a viscous composition to a surface of a substrate to form a layer of viscous composition on the surface of the substrate, wherein the layer of viscous composition has an adhering surface which is in contact with the surface of the substrate and an opposing surface facing away from the surface of the substrate, (b) forming a surface pattern comprising a plurality of protrusions within the opposing surface, and solidifying the layer of viscous composition to (i) provide the slip resistant surface from the surface pattern, and (ii) bond the adhering surface to the surface of the substrate.

In other embodiments, a slip resistant substrate can include a substrate layer comprising a substrate surface; a solidified viscous composition layer comprising an adhering surface bonded to the substrate surface and an opposing surface facing away from the substrate surface; and a surface pattern comprising a plurality of protrusions formed within the opposing surface to provide a slip resistant surface.

In a second aspect of the present invention there is provided a slip resistant substrate comprising a slip resistant surface obtained or obtainable by the first aspect or any embodiment thereof.

In a third aspect of the present invention there is a slip resistant substrate comprising (a) a substrate layer comprising a substrate surface, (b) a solidified viscous composition layer comprising an adhering surface bonded to the substrate surface and an opposing surface facing away from the substrate surface and (c) a surface pattern comprising a plurality of protrusions formed within the opposing surface to provide a slip resistant surface.

The substrate may be formed of any suitable material. The substrate may comprise glass fibers, cellulosic fibers, ceramic fibers, carbon fibers, mineral fibers, plastic fibers, polymeric fibers, synthetic fibers, fiber sheets, fabric, a fiber web, or combinations thereof. The substrate may be a lignocellulosic material, a glass substrate, or a clay substrate. The glass substrate may include fillers such as N600 ceramic microspheres, expandable graphite, DURALUM fused brown aluminum oxide, and combinations thereof.

The lignocellulosic material may be paper. Other examples of lignocellulosic materials include materials comprised of cellulose, hemicellulose, and lignin. Such materials include solid lumber, laminated veneer lumber, parallel strand lumber, timber strands, plywood, medium density fiberboard (MDF), hardboard, particleboard, oriented strand board (OSB), and strawboard. The substrate may a gypsum board.

The substrate may be a wood-based material. Examples of suitable wood-based materials include, but are not limited to, plywood, oriented strand board (OSB), waferboard, medium density fibreboard (MDF), timber-board, chipboard, hardboard or any combination thereof.

In one preferred embodiment the substrate is plywood. In another preferred embodiment the substrate is oriented strand board (OSB). In another preferred embodiment the substrate is medium density fibre board (MDF). In another preferred embodiment the substrate is chipboard. In yet another preferred embodiment the substrate is particleboard. The substrate may comprise more than one material or more than one layer, for example the substrate may be a wood-based material but further comprises a thermally insulating layer and/or a plurality of timber studs. Accordingly, in some embodiments, the substrate comprises a base material and a thermally insulating layer. The layer of viscous composition, having the surface pattern, may be applied to the thermally insulating layer or to the base material depending on the requirements.

In preferred embodiments, the substrate is a construction panel. The construction panel may be made of a wood-based material; optionally wherein the construction panel is made of plywood, oriented strand board (OSB), waferboard, medium density fibreboard (MDF), timber-board, chipboard, hardboard or any combination thereof. In embodiments, the construction panel is made of chipboard.

### BRIEF DESCRIPTION OF THE DRAWINGS

Some embodiments of the present invention are described more fully hereinafter with reference to the accompanying figures. In the figures, dimensions may be exaggerated for clarity of illustration.

FIG. 1 shows a schematic wherein an exemplary slip resistant construction panel is provided.

FIG. 2 shows an exemplary heater roller coater used to apply adhesive composition to the surface of an exemplary construction panel.

FIG. 3 shows an image of an exemplary slip resistant construction panel comprising a surface pattern.

FIG. 4 shows an image of an exemplary slip resistant construction panel comprising a diamond-square shaped surface pattern.

FIG. 5 shows an image of an exemplary slip resistant construction panel comprising a hexagonal surface pattern.

FIG. 6 shows application of an adhesive composition to the surface of an exemplary construction panel.

In the following detailed description, only certain embodiments of the present invention have been shown and described, simply by way of illustration. As those skilled in the art would realise, the described embodiments may preferably be modified in various different ways, all without departing from the spirit or scope of the present invention. Accordingly, the drawings and description are to be regarded as illustrative in nature and not restrictive.

### DETAILED DESCRIPTION OF THE INVENTION

In some embodiments, a method of preparing a substrate comprising a slip resistant surface, the method can include applying a viscous composition to a surface of a substrate to form a layer of viscous composition on the surface of the substrate, wherein the layer of viscous composition has an adhering surface which is in contact with the surface of the substrate and an opposing surface facing away from the surface of the substrate; forming a surface pattern comprising a plurality of protrusions within the opposing surface; and solidifying the layer of viscous composition to (i) provide the slip resistant surface from the surface pattern; and (ii) bond the adhering surface to the surface of the substrate.

In another embodiment, the substrate is a construction panel.

In some embodiments, the viscous composition has a viscosity of about 5000 cPs @ 120° C. to about 15,000 cPs @ 120° C.

In other embodiments, the viscous composition has a viscosity of about 7500 cPs @ 120° C. to about 12,500 cPs @ 120° C.

In certain embodiments, the viscous composition is an adhesive composition.

In further embodiments, the adhesive composition is selected from the group consisting of a hot melt adhesive, a photo sensitive adhesive, a drying adhesive and combination thereof.

In certain embodiments, the adhesive composition is the hot melt adhesive.

In further embodiments, applying the adhesive composition to the surface of the substrate is performed at an application temperature of about 80° C. to about 180° C.

In some embodiments, applying the viscous composition comprises application of the viscous composition at coat weight of about 80 grams per square metre (g/m²) to about 180 grams per square metre (g/m²).

In other embodiments, applying the viscous composition comprises application of the viscous composition at coat weight of about 120 grams per square metre (g/m²) to about 140 grams per square metre (g/m²).

In certain embodiments, solidifying the layer of viscous composition comprises reducing a temperature of the viscous composition.

In some embodiments, reducing the temperature is performed from about 1 hour to about 72 hours.

In other embodiments, reducing the temperature is performed from about 24 hours to about 48 hours.

In certain embodiments, (i) applying the viscous composition to the surface of the substrate and forming the surface pattern occur concurrently; or (ii) forming the surface pattern is performed subsequent to applying the viscous composition to the surface of the substrate.

In further embodiments, applying the viscous composition to the surface of the substrate and forming the surface pattern comprises using a roller coater.

In certain embodiments, forming the surface pattern occurs whilst applying the viscous composition to a surface of the substrate due to the viscous composition undergoing pull-off from a surface of the roller coater.

In further embodiments, applying the viscous composition to the surface of the substrate and forming the surface pattern comprises using the roller coater at a line speed of from about 3 metres per minute (m/m) to about 20 metres per minute (m/m).

In another embodiment, the surface of the roller coater comprises an embossed pattern.

In further embodiments, the construction panel is made of a wood-based material.

In certain embodiments, the wood-based material is selected from the group consisting of plywood, oriented strand board (OSB), waferboard, medium density fibreboard (MDF), timber-board, chipboard, hardboard and combination thereof.

In further embodiments, a slip resistant substrate comprising a slip resistant surface obtained or obtainable by a method of preparing a substrate.

In other embodiments, a slip resistant substrate can include a substrate layer comprising a substrate surface; a solidified viscous composition layer comprising an adhering surface bonded to the substrate surface and an opposing surface facing away from the substrate surface; and a surface pattern comprising a plurality of protrusions formed within the opposing surface to provide a slip resistant surface.

In another embodiment, the substrate is a construction panel.

The term “construction panel” is intended to indicate a structural building element suitable for use in the construction of a building. The panel is typically rectangular in shape. Where the construction panel is rectangular in shape, there is a long edge, a short edge, a top surface, a width defined by a measurement extending orthogonally from one long edge across the top surface to the other long edge and a length defined by a measurement extending orthogonally from one short edge across the top surface to the other short edge. Where the construction panel is a square, the edges of the panel will be equal in length and its width is defined by a measurement extending orthogonally across a top surface between opposing edges.

Typically, the construction panels may have a panel width of from about 300 mm to about 1400 mm, panel length of from about 1000 mm to about 5000 mm and a panel height/thickness of from about 3 mm to about 100 mm. More preferably, the construction panels may have a panel width of about 600 mm, panel length of from about 2400 mm and a panel height/thickness of about 22 mm. In some embodiments, the construction panels may have a panel height/thickness of from about 3 mm to about 100 mm, from about 10 mm to about 100 mm, from about 20 mm to about 100 mm, from about 30 mm to about 100 mm, from about 40 mm to about 100 mm, from about 50 mm to about 100 mm, from about 60 mm to about 100 mm, from about 70 mm to about 100 mm, from about 80 mm to about 100 mm, from about 10 mm to about 90 mm, from about 10 mm to about 80 mm, from about 10 mm to about 70 mm, from about 10 mm to about 60 mm, from about 10 mm to about 50 mm, from about 10 mm to about 40 mm, from about 10 mm to about 30 mm, from about 20 mm to about 50 mm, from about 10 mm to about 40 mm or from about 20 mm to about 40 mm.

The construction panels may also include a suitable installation system which allows separate construction panels to be connected to one another in order to form a larger surface, such as a floor, wall, ceiling or roof. For example, the construction panels may include tongue and groove profiled edges to allow for the connecting of separate panels together.

The construction panel may be a floor or flooring panel. The construction panel may be a wall panel. The construction panel may be a roofing panel. Preferably, the construction panel is a slip resistant flooring panel.

The terms “slip resistant substrate”, “slip resistant construction panel”, “slip resistant floor panel” and “slip resistant surface” are intended to indicate a substrate, construction panel, floor panel or surface that has been processed so as to enhance its surface friction when contacted in order to avoid undesirable surface slipping. For example, when referred to herein, the term “slip resistant floor panel” refers to a floor panel that has been processed to include a surface which, when walked upon by a person, reduces the risk of that person slipping on the surface.

As used herein, the term “viscous composition” refers to any composition which is suitably viscous to the extent that, when applied to a surface of a substrate to form a viscous composition layer on the surface of the substrate, a surface pattern can be integrally formed within the layer of viscous composition and will remain intact if undisturbed. In embodiments, the viscous composition must have suitable flow properties such that before being solidified the composition can be easily applied and coated onto a substrate surface. In some embodiments, the viscous composition has a viscosity of from about 5000 centipoise (cPs) @ 120° C. to about 15,000 cPs @ 120° C., preferably, the viscous composition has a viscosity of from about 7500 cPs @ 120° C. to about 12,500 cPs @ 120° C. In other embodiments, the viscous composition has a viscosity of from about 8000 cPs @ 120° C. to about 12,000 cPs @ 120° C., the viscous composition has a viscosity of from about 9000 cPs @ 120° C. to about 11,000 cPs @ 120° C. or the viscous composition has a viscosity of from about 9500 cPs @ 120° C. to about 10,500 cPs @ 120° C. Preferably, the viscous composition has a viscosity of from about 9000 cPs @ 120° C. to about 11,000 cPs @ 120° C. Viscosity values as disclosed herein are measured using the ASTM test method “Standard Test Method for Apparent Viscosity of Hot Melt Adhesives and Coating Materials” issued under the designation D3236-88.

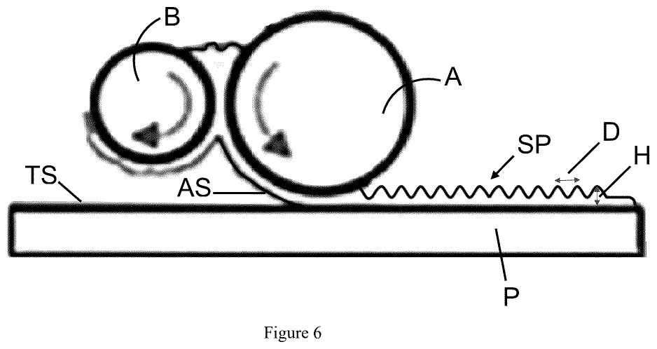

In accordance with embodiments of the present invention, the layer of viscous composition has an adhering surface which is in contact with the surface of the substrate before then bonding to the surface of the substrate. It will be appreciated that the “adhering surface” is formed when applying the viscous composition to the substrate to form the layer of viscous composition. The adhering surface corresponds to a portion of the layer of viscous composition, which during application to the substrate, comes into direct contact with the surface of the substrate. The adhering surface is a surface which is suitable for bonding or fixing the layer of viscous composition to the surface of the substrate or construction panel once the viscous composition has solidified, as described herein. FIG. 6 shows an exemplary substrate in the form of a construction panel (P) wherein the adhering surface is labelled by (AS) and the top surface of the substrate is labelled by (TS).

The viscous composition must necessarily be capable of solidifying when formed as the layer of viscous composition as described herein. This results in the surface pattern formed within the layer of viscous composition becoming fixed, set, cured or hardened so as to form a permanent slip resistant surface. In addition to providing the slip resistant surface, the layer of viscous composition undergoes bonding, via its adhering surface, to the surface of the substrate whilst undergoing the step of solidifying.

As it will be appreciated, the term “bond” or “bonding” refers to the fixing or securing of two separate surfaces together (e.g. the fixing or securing of the adhering surface (as referred to herein) and the surface of a substrate). This may include the formation of covalent bonds, ionic bonds, dipole-dipole bonding, hydrogen-bonding, Van der Waal forces or alike.

In embodiments, the viscous composition is an adhesive composition. The term “adhesive composition” is intended to indicate any substance which, when applied to a surface of an article (e.g. a surface of a substrate such as a construction panel), is capable of bonding to the surface resist separation. The term “adhesive composition” may be used interchangeably with the term “adhesive” for the purposes of this invention.

It will be appreciated that the step of solidifying the layer of viscous composition to (i) provide the slip resistant surface from the surface pattern, and (ii) bond the adhering surface to the surface of the substrate may occur via different chemical reactions which will depend upon the type of viscous composition used. For example, where the viscous composition is a photo sensitive adhesive composition, the step of solidifying may be achieved by initiating a photo-catalysed reaction. In some embodiments, where the viscous composition is a hot melt adhesive composition, the step of solidifying may be achieved by allowing the hot melt adhesive to cool from an elevated temperature to a lower temperature (e.g. room temperature).

Typically, the adhesive composition is a hot melt adhesive, photo sensitive adhesive, drying adhesive or any combination thereof, preferably, the adhesive composition is a hot melt adhesive.

In some embodiments, the adhesive composition is a hot melt adhesive. Where the adhesive composition is a hot melt adhesive, the composition may include waxes, resins, ethylene-vinyl acetate copolymers, polyolefins, polyamides, polyesters, polyurethanes, styrene block copolymers, polycaprolactones, polycarbonates, fluorinated polymers, silicone based polymers, polypyrroles or any combination thereof.

In embodiments, the hot melt adhesive includes polyurethanes or is a polyurethane based hot melt adhesive, such as, Abrabond Apollo A1024. In some embodiments, the polyurethane based hot melt adhesive has a viscosity of from about 5000 cPs @ 120° C. to about 15,000 cPs @ 120° C., preferably, the polyurethane based hot melt adhesive has a viscosity of from about 7500 cPs @ 120° C. to about 12,500 cPs @ 120° C. In other embodiments, the polyurethane based hot melt adhesive has a viscosity of from about 8000 cPs @ 120° C. to about 12,000 cPs @ 120° C., the viscous composition has a viscosity of from about 9000 cPs @ 120° C. to about 11,000 cPs @ 120° C. or the polyurethane based hot melt adhesive has a viscosity of from about 9500 cPs @ 120° C. to about 10,500 cPs @ 120° C. Preferably, the polyurethane based hot melt adhesive has a viscosity of from about 9000 cPs @ 120° C. to about 11,000 cPs @ 120° C. Viscosity values as disclosed herein are measured using the ASTM test method “Standard Test Method for Apparent Viscosity of Hot Melt Adhesives and Coating Materials” issued under the designation D3236-88.

Examples of the adhesive compositions suitable for use in the present invention, together with grades and viscosity measurements, are as illustrated in the Table 1 below.

TABLE 1
Examples of adhesive compositions

| Supplier | Grade | Viscosity |
|---|---|---|
| Abrabond Apollo | A1024 | 10000 cPs @120° C. |
| Abrabond ™ | AB464HM | 1700 cPs @ 160° C. |
| Adhesives direct ™ | AD826 | 1750 cPs @ 160° C. |
| Adhesives direct ™ | AD851 | 1900 cPs @ 160° C. |
| Alphabond Adhesives ™ | Fastlock 66x | 1850 cPs @ 160° C. |
| Alphabond Adhesives ™ | Fastlock 30029 | 1700 cPs @ 160° C. |
| Beardow Adams ™ | Prodas 2308 | 1795 cPs @ 160° C. |
| Beardow Adams ™ | Prodas 1507 | 1700 cPs @ 160° C. |
| Beardow Adams ™ | Prodas 2247 | 3080 cPs @ 160° C. |
| Bostik ™ | Thermogrip 9691 | 1300 cPs @ 170° C. |
| Caswell Adhesives ™ | Premiermelt 178PA | 1450 cPs @ 160° C. |
| Colquimica ™ | K-melt C2310 | 1000 cPs @ 160° C. |
| HB Fuller ™ | Swift-therm 9119 | 2200 cPs @ 150° C. |
| Jowat Adhesives ™ | Jowatherm 261.40 | 1800 cPs @ 180° C. |

In embodiments, the adhesive composition is a photo sensitive adhesive such as a UV (ultra-violet) curable adhesive. A UV curable adhesive is one which hardens under irradiation of UV (ultraviolet) light. For example, the curing may occur by the UV light initiating a photochemical reaction that generates a cross-linked network of polymers.

For avoidance of doubt, a hot melt adhesive may also be a UV curable adhesive. For example, the adhesive may be applied hot and partially set upon cooling but then further harden under UV irradiation.

Where the adhesive composition is a UV curable adhesive, the method preferably comprises a step of solidifying via curing of the UV curable adhesive. The step of curing the UV curable adhesive may involve irradiating the adhesive composition with UV light, e.g. using a UV lamp.

In certain embodiments, the adhesive composition is a hot melt adhesive composition, preferably a polyurethane based hot melt adhesive, and applying the hot melt adhesive composition to the surface of the substrate is performed at an application temperature of from about 80° C. to about 180° C. Suitable application temperatures may depend on the type of adhesive composition(s) being used and may include, but are not limited to, a temperature of from about 50° C. to about 200° C., from about 50° C. to about 150° C., from about 100° C. to about 200° C., from about 120° C. to about 180° C., from about 40° C. to about 160° C. Typically, applying the hot melt adhesive composition to the surface of the substrate is performed at from about 125° C. to about 175° C. or from about 80° C. to about 150° C. For example, the step of applying the hot melt adhesive composition to the surface of the substrate is performed at a temperature of from about 100° C. to about 150° C. or of from about 100° C. to about 120° C.

In embodiments, the surface of the substrate (e.g. top surface of the construction panel as labelled by (TS) in FIG. 6) has an elevated temperature prior to the step of applying the viscous composition to the surface of the substrate to form the layer of viscous composition on the surface of the substrate (i.e. the surface of the substrate/panel may be pre-heated prior to application of the viscous composition). This is generally useful in overcoming problems/issues associated with applying hot melt adhesives to the surface of the substrate wherein the surface of the substrate is at ambient temperature. For example, increasing the temperature of the surface of the substrate to which the hot melt adhesives is to be applied may aid the flow and adhesive properties of the hot melt adhesives composition and prevent stringing of the hot melt adhesives composition during application. The degree of temperature elevation will depend on the hot melt adhesives being used. Suitable temperatures at which to elevate the surface of the substrate prior to applying the hot melt adhesive composition may include a temperature of from about 5° C. to about 60° C., more preferably from about 40° C. to about 60° C. or about 45° C. The substrate may be heated using any suitable heating means, for example, radiant gas heaters.

As disclosed herein, applying the viscous composition may comprise application of the viscous composition at coat weight of from about 80 grams per square metre (g/m²) to about 180 grams per square metre (g/m²), preferably, from about 120 grams per square metre (g/m²) to about 140 grams per square metre (g/m²). In embodiments, applying the viscous composition comprises application of the viscous composition at coat weight of from about 80 grams per square metre (g/m²) to about 180 grams per square metre (g/m²), from about 80 grams per square metre (g/m²) to about 160 grams per square metre (g/m²), from about 80 grams per square metre (g/m²) to about 140 grams per square metre (g/m²), from about 80 grams per square metre (g/m²) to about 120 grams per square metre (g/m²), from about 80 grams per square metre (g/m²) to about 100 grams per square metre (g/m²), from about 100 grams per square metre (g/m²) to about 180 grams per square metre (g/m²), from about 120 grams per square metre (g/m²) to about 180 grams per square metre (g/m²), from about 140 grams per square metre (g/m²) to about 180 grams per square metre (g/m²) or from about 160 grams per square metre (g/m²) to about 180 grams per square metre (g/m²).

In embodiments, solidifying the layer of viscous composition comprises reducing the temperature of the viscous composition; optionally; wherein reducing the temperature is performed for from about 1 hour to about 72 hours, preferably, from about 24 hours to about 48 hours. In some embodiments, reducing the temperature is performed from about 1 hour to about 60 hours, from about 1 hour to about 48 hours, from about 1 hour to about 36 hours, from about 1 hour to about 24 hours, from about 1 hour to about 12 hours, from about 1 hour to about 6 hours, from about 12 hours to about 72 hours, from about 24 hours to about 72 hours, from about 36 hours to about 72 hours, from about 48 hours to about 72 hours or from about 60 hours to about 72 hours. It will be appreciated that where the viscous composition is a hot melt adhesive composition, the step of solidifying involves reducing the temperature as the hot melt adhesive composition cools from its elevated application temperature (e.g. from about 100° C. to about 120° C.) to an ambient room temperature (e.g. from about 10° C. to about 30° C.). In embodiments, reducing the temperature of the hot melt adhesive comprises drying by movement of air across its surface (e.g. using cooling fans). It will be appreciated that during the step of solidifying, the viscous composition (e.g. hot melt adhesive composition) undergoes curing, setting or hardening.

In some embodiments, applying the viscous composition to the surface of the substrate and forming the surface pattern occur concurrently. This can be achieved, for example, by using any suitable technique which allows the immediate formation of the surface patterns as the viscous composition is applied to the surface of the substrate. In some embodiments, it is possible to use a roller coater to apply the viscous composition and concurrently, or simultaneously, form the surface pattern. As described herein, this can be achieved when the viscous composition undergoes pull-off from the surface of the roller coater to create the surface pattern upon application to the surface of the substrate. It is also possible to use a roller coater having a surface pattern cut into the surface of its application roller in order to concurrently, or simultaneously, form the surface pattern during application of the viscous composition.

In other embodiments, forming the surface pattern is performed subsequent to applying the viscous composition to the surface of the substrate. This can be achieved, for example, by applying the viscous composition to the surface of the substrate to form a uniform layer (flat or even surface) of viscous composition before then subsequently embossing or printing the surface pattern into the uniform layer of the viscous composition by any suitable technique.

As disclosed herein, applying the viscous composition to the surface of the substrate and forming the surface pattern comprises using a roller coater. The roller coater may comprise an application roller and dosing roller. The application roller, in some embodiments, includes a roller surface made of silicon rubber and may be flat or smooth. The dosing roller may be a steel dosing roller. Typically, in embodiments where the viscous composition is a hot melt adhesive composition (e.g. polyurethane hot melt adhesive such Abrabond Apollo A1024), the dosing roller is heated to from about 125° C. to about 175° C. or approximately 150° C. In embodiments where the viscous composition is a hot melt adhesive composition (e.g. polyurethane hot melt adhesive such Abrabond Apollo A1024), the application roller is heated to from about 40° C. to about 60° C. or approximately 50° C.

In embodiments, forming the surface pattern occurs whilst applying the viscous composition to a surface of the substrate due to the viscous composition undergoing pull-off from a surface of the roller coater. It will be appreciated that surface pattern will be provided within the top surface of the viscous composition. The surface pattern may be integrally formed and shaped from the viscous composition material itself and is not attributed to the presence of any additive materials (e.g. aggregate, grit or particulate matter). In embodiments, the surface pattern is integrally formed within the viscous composition and consists only of the viscous composition material (e.g. polyurethane hot melt adhesive such Abrabond Apollo A1024)

In embodiments, pull-off of the viscous composition from the surface of the roller coater, in particular the silicone rubber application roller, occurs to form the surface pattern. This may occur as viscous composition, which is in contact with both the surface of the substrate and the application roller, undergoes adhesive failure with the application roller. This is where the viscous composition, which is located between the surface of the application roller and the substrate, pulls off and away from the application roller to form the surface pattern. That is, the viscous composition, which is located between the surface of the application roller and the substrate, separates from the application roller due to its greater degree of adhesion to the substrate as compared to the application roller. This pull-off effect may create a rippled, stippled or dappled surface pattern.

In some embodiments, applying the viscous composition to the surface of the substrate to form the layer of viscous composition on the surface of the substrate can be performed using a roller coater. In such embodiments, the roller coater may apply an application force to the surface of the substrate whilst applying the viscous composition. Further, the roller coater can comprise an application roller that applies an application force to the surface of the substrate whilst applying the viscous composition. The application force may be any suitable force applied from the roller coater to the substrate and which allows a surface pattern to be integrally formed within the layer of viscous composition, preferably, via the pull-off effect described herein. The application force may be from about 20 MPa to about 50 MPa. In some embodiments, the application force may be from about 0.1 MPa to about 30 MPa, from about 0.5 MPa to about 25 MPa, from about 1 MPa to about 10 MPa, or from about 1 MPa to about 5 MPa. The application force may be from about 20 kPA to about 2500 kPa. In some embodiments, the application force may be from about 100 kPa to about 1500 kPa, from about 200 kPa to about 2000 kPa, from about 1000 kPa to about 1500 kPa, from about 1500 kPa to about 2000 kPa. Preferably the application force is from about 1000 kPa to about 2000 kPa. Even more preferably, the application force is of from about 1200 kPa, about 1600 kPa or about 1500 kPa.

In some embodiments, the surface of the roller coater comprises an embossed pattern. In embodiments, the application roller of the roller coater includes an embossed pattern or pattern cut into its roller surface. In such embodiments, forming the surface pattern occurs whilst applying the viscous composition to a surface of the substrate due to the embossed roller coater surface printing, pressing or embossing the pattern into the surface of the viscous composition.

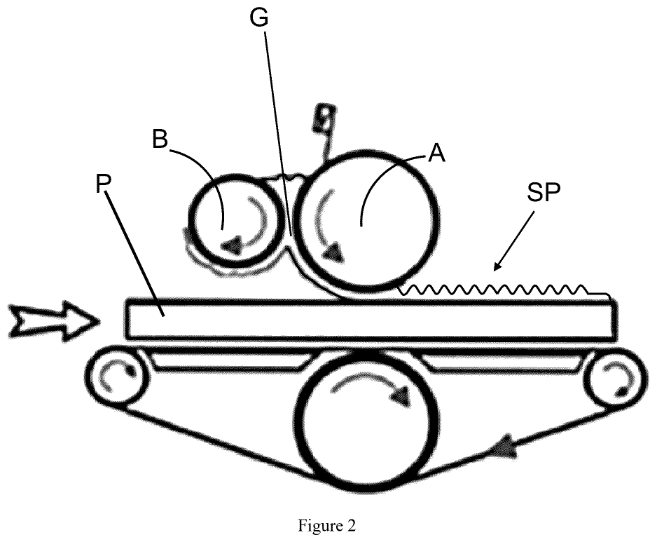

The surface pattern comprises a regular or irregular pattern. In embodiments, the surface pattern comprises a dappled, stippled or rippled finish. The surface pattern may include an undulating wave-like profile when viewed along its cross section (as shown in FIGS. 2 and 6 wherein the surface pattern is labelled as (SP)). In addition or alternatively, the surface pattern may also include geometrical shapes in a regular or repeating pattern. In some embodiments, the geometrical shapes may include a square, triangle, circle, hexagon, pentagon, octagon, rhombus, oval, trapezium, rectangle, parallelogram or any combination thereof.

As disclosed herein, the surface pattern comprises a plurality of protrusions. By this, it will be understood that the surface pattern includes regions where the viscous composition (e.g. hot melt adhesive composition) is raised in a direction which is perpendicular to the plane of the substrate surface or the layer of viscous composition. For illustrative purposes, this is depicted in FIG. 6 wherein the height of one of the protrusions is labelled (H). As can be seen from the cross section view in FIG. 6, the height of the protrusions is measured from the top surface (TS) of the panel (P) to the highest most point of the protrusions (i.e. the peak of the protrusions).

In embodiments, the height of the protrusions may be from about 0.25 mm to about 25 mm, preferably, from about from about 0.25 mm to about 0.75 mm. In some embodiments, the height of the protrusions may be from about 0.25 mm to about 20 mm, from about 0.25 mm to about 15 mm, from about 0.25 mm to about 10 mm, from about 0.25 mm to about 5 mm, from about 0.25 mm to about 1 mm, from about 0.25 mm to about 0.5 mm, from about 0.5 mm to about 25 mm, from about 1 mm to about 25 mm, from about 5 mm to about 25 mm, from about 10 mm to about 25 mm, from about 15 mm to about 25 mm or from about 20 mm to about 25 mm.

The protrusions can be separated, or spaced, by a distance of from about 0.5 mm to about 1 mm. This distance is measured starting from the peak of a given protrusion and ending at the peak of an adjacent protrusion, as can be seen in FIG. 6 wherein the distance is labelled as (D). In embodiments, the protrusions can be separated by a distance of from about 0.25 mm to about 2 mm, from about 0.25 mm to about 1 mm, from about 0.25 mm to about 0.75 mm, from about 0.5 mm to about 2 mm, from about 0.75 mm to about 2 mm, from about 1 mm to about 2 mm, from about 1.25 mm to about 2 mm, from about 1.5 mm to about 2 mm or from about 1.75 mm to about 2 mm.

As described herein, applying the viscous composition to the surface of the substrate and forming the surface pattern comprises using the roller coater at a line speed of from about 3 metres per minute (m/m) to about 20 metres per minute (m/m) or about 10 metres per minute (m/m) to about 15 metres per minute (m/m). In embodiments, applying the viscous composition to the surface of the substrate and forming the surface pattern comprises using the roller coater at a line speed of from about 3 metres per minute (m/m) to about 20 metres per minute (m/m), about 5 metres per minute (m/m) to about 20 metres per minute (m/m), about 10 metres per minute (m/m) to about 20 metres per minute (m/m), about 15 metres per minute (m/m) to about 20 metres per minute (m/m), about 5 metres per minute (m/m) to about 15 metres per minute (m/m) or about 5 metres per minute (m/m) to about 10 metres per minute (m/m).

It will be appreciated that slip resistant properties of the substrates and surfaces described herein can be measured using the Pendulum test method in accordance with the British Standard BS 7976, as described herein, and presented as an average pendulum test value (PVT) (measured under dry or wet conditions). In embodiments, the substrate (e.g. construction panel or flooring panel) may have a PVT (dry) of greater than 25 or greater than 36. In some embodiments, the substrate (e.g. construction panel or flooring panel) may have a PVT (dry) of a least 50, from 50 to 70, from 50 to 60 or about 56. In embodiments, the substrate (e.g. construction panel or flooring panel) may have a PVT (wet) of greater than 25 or greater than 36. In some embodiments, the substrate (e.g. construction panel or flooring panel) may have a PVT (wet) of a least 40, from 40 to 70, from 40 to 60, from 40 to 50 or about 47.

It will be appreciated that, in embodiments, there is a step of applying a carrier layer (e.g. intermediate layer) to the surface of the substrate before then applying the viscous composition to the surface of the carrier layer and forming the surface pattern as described herein. The carrier layer may be a paper sheet (or paper overlay) as described herein. In such embodiments, the method comprises the steps of (i) applying an adhesive composition to the surface of the substrate to provide a substrate bonding surface and (ii) bonding the substrate bonding surface to a carrier layer. For the avoidance of doubt, in these embodiments, the step of applying a viscous composition to a surface of a substrate to form a layer of viscous composition on the surface of the substrate may include applying the viscous composition to the surface of a carrier layer to form the layer of viscous composition on the carrier layer.

In some embodiments, the substrate (e.g. construction panel or flooring panel) may not have an even surface. It may have an uneven outer surface (i.e. the surface of the substrate on which the viscous composition is to be applied may be uneven). For example, the surface of the substrate may be potholed, rutted, splintered, unevenly contoured surface or any combination thereof. It may be formed out of overlapping wood strands. An uneven surface may generally be difficult to treat or process to form a slip resistant surface. Examples of substrates (e.g. construction panels) having an uneven surface include, but are not limited to, OSB and Waferboard.

In embodiments where the substrate has an uneven surface, the method may further comprise the step of processing the substrate to modify the uneven surface to provide (i) a uniform surface on which to apply the viscous composition; and/or (ii) a substantially uniform thickness across the entire substrate, prior to the step of applying a viscous composition to a surface of a substrate to form a layer of viscous composition on the surface of the substrate.

In embodiments, the method comprises the steps of (a) processing the substrate to modify the uneven surface to provide (i) a uniform surface; and/or (ii) a substantially uniform thickness across the entire substrate, (b) applying an adhesive composition to the uniform surface to provide a substrate bonding surface and (c) bonding the substrate bonding surface to a carrier layer or paper sheet. In such embodiments, the step of applying a viscous composition to a surface of a substrate to form a layer of viscous composition on the surface of the substrate may include applying the viscous composition to the carrier layer (e.g. paper sheet) to form the layer of viscous composition on the carrier layer (e.g. paper sheet).

It will be appreciated a further balancing paper sheet may be applied and bonded to a surface of the substrate that is opposite to the surface on which the carrier layer (e.g. first paper sheet) is bonded. For example, if the carrier layer is bonded to a top surface of the substrate, the method further includes bonding a balancing paper sheet to the bottom surface of the substrate. The balancing paper sheet is intended to increase the overall structural stability of the substrate and prevent warping of the substrate, which can sometimes occur when applying a carrier layer or paper sheet to a substrate. The application of a balancing paper sheet to the substrate is especially useful when the substrate is to be used for flooring applications.

It will be appreciated that the carrier layer may be any paper based sheet material suitable for lining the surface of a substrate (e.g. construction panel) and applying a viscous composition thereon. In embodiments, the paper sheet is a building paper sheet or kraft paper sheet. In embodiments, the paper sheet and the balancing paper sheet are the same material. Examples of suitable building paper include Arclin® Guardsman™, Arclin® 4600, Arclin ReadyPrime 4047®, and Arctek® Dryshell™.

It will be appreciated that the term “uniform surface” is intended to indicate a surface of the substrate that is substantially flat and smooth (e.g. outer surface or top surface of the substrate). That is, it will be understood that the uniform surface has undergone a step of processing in order to remove a potholed, splintered and/or unevenly contoured surface. The uniform surface will be suitable for applying a viscous composition to a surface of a substrate to form a layer of viscous composition on the uniform surface of the substrate or bonding paper sheet in order to create a uniform, smooth and substantially flat surface on which a slip resistant surface can be formed.

It will be appreciated that by “substantially uniform thickness across the entire substrate” it is meant that the substrate undergoing the step of processing results in a thickness variation that is minimised to the extent that the uniformity of viscous composition application step and bonding of a carrier layer, paper sheet or balancing paper sheet step is not compromised. In some embodiments, the step of processing the substrate to modify the uneven surface includes removing swollen/thickened edge portions of the substrate. This removes downstream issues associated with substrates which have non-uniform thickness profiles. Such issues include substrate becoming stuck within production line machinery or facilities due to the substrate having an undesired thickness profile (e.g, wherein the substrate thickness exceeds the production line machinery tolerance limits).

In embodiments, there is a step of processing the substrate to modify the uneven surface to provide a uniform surface only. In other embodiments, there is a step of processing the substrate to modify the uneven surface to provide a substantially uniform thickness across the entire substrate only. In further embodiments, there is a step of processing the substrate to modify the uneven surface to provide a uniform outer surface and a substantially uniform thickness across the entire substrate. It is will be appreciated that where both a uniform surface and a substantially uniform thickness across the entire substrate are achieved, the step of processing may include a single step (e.g. a single calibration sanding step) or two or more steps (e.g. a calibration sanding step followed by a finishing sanding).

In embodiments, the step of processing the substrate to modify the uneven surface to provide a uniform surface and/or a substantially uniform thickness across the entire substrate comprises sanding the uneven surface. It will be appreciated that sanding may include one or more sanding so as to achieve a uniform surface and/or a substantially uniform thickness across the entire substrate. Preferably, the step of sanding provides both a uniform surface and a substantially uniform thickness across the entire substrate.

In embodiments, the step of sanding comprises performing a step of calibration sanding. The step of calibration sanding may be performed using a sanding paper having a grit size of from about 60 to about 100, from about 70 to about 90, preferably, a grit size of from about 60 to about 80. In such embodiments, there may be an optional step of finishing sanding. The step of finishing sanding may be performed using a sanding paper having a grit size of from about 240 to about 280, about 250 to about 270, preferably, a grit size of about 260 to about 280.

It will be appreciated that in embodiments comprising substrates formed of overlapping wood stands, along with other substrates having recess within their outer surface, that the depth of the recesses is decreased upon performing the step of processing the substrate. For example, where the step of processing the substrate includes a step of sanding the uneven surface (e.g. calibration sanding and/or finishing sanding), the depth of the recesses forming part of the uneven surface is decreased as a result of substrate material being removed from the outer surface (e.g. abraded away) during the sanding process. In embodiments, the decrease in the depth of the recesses forming part of the uneven surface is from about 0.05 mm to about 5 mm or about 0.1 mm to about 1 mm. In other embodiments, the decrease in the depth of the recesses forming part of the uneven surface is from about 0.2 mm to about 1 mm, from about 0.3 mm to about 1 mm, from about 0.4 mm to about 1 mm, from about 0.5 mm to about 1 mm, from about 0.1 mm to about 0.9 mm, from about 0.1 mm to about 0.8 mm, from about 0.1 mm to about 0.7 mm, from about 0.1 mm to about 0.6 mm or from about 0.1 mm to about 0.5 mm. In embodiments, the plurality of recesses in the uneven surface have a depth of from about 0.5 mm to about 20 mm and wherein the depth is decreased upon performing the step of processing the substrate (e.g. the decrease in the depth of the recesses forming part of the uneven surface is from about 0.1 mm to about 1 mm upon).

In a fourth aspect of the present invention there is provided a method of preparing a substrate comprising a slip resistant surface, the method comprising the steps of (a) applying a polyurethane based hot melt adhesive to a surface of a substrate to form a layer of polyurethane based hot melt adhesive on the surface of the substrate, wherein the layer of polyurethane based hot melt adhesive has an adhering surface which is in contact with the surface of the substrate and an opposing surface facing away from the surface of the substrate, (b) forming a surface pattern comprising a plurality of protrusions within the opposing surface, and solidifying the layer of polyurethane based hot melt adhesive to (i) provide the slip resistant surface from the surface pattern, and (ii) bond the adhering surface to the surface of the substrate. Optionally, in the fourth aspect of the present invention the step of applying a polyurethane based hot melt adhesive to a surface of a substrate to form a layer of polyurethane based hot melt adhesive on the surface of the substrate may include applying the polyurethane based hot melt adhesive to the surface of a carrier layer to form the layer of polyurethane based hot melt adhesive on the carrier layer.

In embodiments of the fourth aspect of the invention, the viscous composition is a hot melt adhesive which includes polyurethanes or is a polyurethane based hot melt adhesive, such as, Abrabond Apollo A1024. Preferably, the polyurethane based hot melt adhesive has a viscosity of from about 9000 cPs @ 120° C. to about 11,000 cPs @ 120° C. In such embodiments, the step of applying the polyurethane based hot melt adhesive composition to the surface of the substrate is performed at a temperature of from about 100° C. to about 150° C. or of from about 100° C. to about 120° C. The surface of the substrate may be elevated prior to applying the polyurethane hot melt adhesive composition to from about 40° C. to about 60° C. The polyurethane based hot melt adhesive is applied to the surface of the substrate to form the layer of viscous composition on the surface of the substrate at a coat weight of from about 120 grams per square metre (g/m²) to about 140 grams per square metre (g/m²). The step of solidifying the layer of viscous composition (i.e. polyurethane based hot melt adhesive composition) comprises reducing the temperature from about 24 hours to about 48 hours. This includes allowing the polyurethane based hot melt adhesive to cool and harden (or cure). In embodiments of the fourth aspect, applying the polyurethane based hot melt adhesive composition to the surface of the substrate and forming the surface pattern occur concurrently. This can be achieved by using a roller coater to apply the polyurethane based hot melt adhesive and concurrently, or simultaneously, forming the surface pattern. Here, the polyurethane based hot melt adhesive undergoes pull-off from the surface of the roller coater to create the surface pattern upon application to the surface of the substrate. The roller coater has an application roller which is heated to from about 40° C. to about 60° C. during the step of applying the viscous composition (i.e. polyurethane based hot melt adhesive composition). The application roller is a silicone rubber application roller. It will be appreciated that surface pattern in accordance with the fourth aspect will be provided within the top surface of the polyurethane based hot melt adhesive. The surface pattern may be integrally formed and shaped from the polyurethane based hot melt adhesive material itself and is not attributed to the presence of any additive materials (e.g. aggregate, grit or particulate matter). In embodiments, the surface pattern is integrally formed within the polyurethane based hot melt adhesive and consists only of the polyurethane based hot melt adhesive (e.g. polyurethane based hot melt adhesive composition such Abrabond Apollo A1024). Applying the polyurethane based hot melt adhesive composition to the surface of the substrate and forming the surface pattern comprises using the roller coater at a line speed of from about 10 metres per minute (m/m) to about 15 metres per minute (m/m).

It will be appreciated that all features described in relation to the first aspect of the invention may also be applicable to the second, third and fourth aspect of the invention. For the avoidance of doubt, where applicable, all features described in relation to the first aspect are intended to be disclosed in relation to the second, third and fourth aspect of the invention.

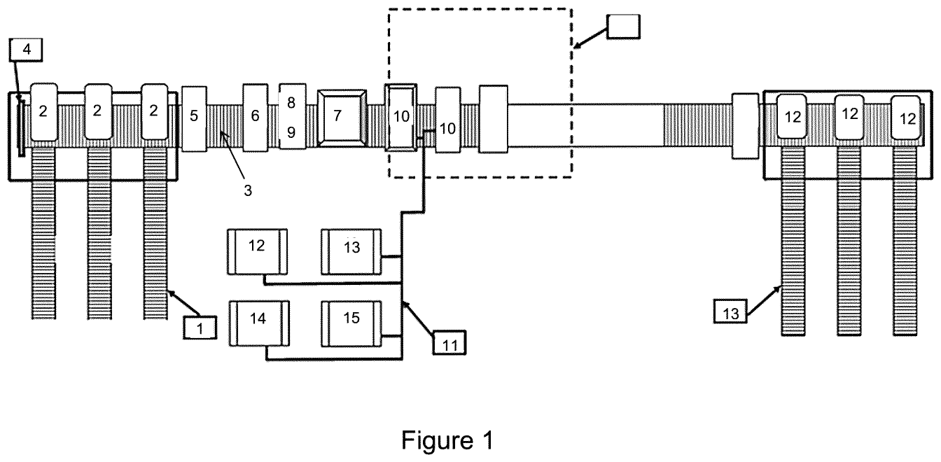

FIG. 1 shows an exemplary schematic wherein a slip resistant construction panel according to an embodiment of the present invention is provided.

Construction panels (not shown) are delivered and loaded onto a feed conveyor system (1). The panels are loaded, using a forklift truck or any other suitable means, onto the feed conveyer system (1) in either single stack or multiple stack arrangements. The feed conveyor system (1) transports the construction panels automatically towards an in-feed vacuum pick-and-place stacking system (2) which in turn transfers the construction panels onto a machine bed (3). Again, the construction panels are loaded on to the machine bed (3), automatically, in either single stack or as multiple stack arrangement.

An in-feed panel pusher (4) then conveys the construction panels along the machine bed (3) and into an in-feed nip roller (5). The construction panels are then automatically conveyed from the in-feed nip roller (5) into a governor roller (6). The governor roller (35) drives the construction panels along the remainder of the machine bed (3) and controls the line speed.

The panels are automatically conveyed from the governor roller (6) towards a heating zone (7).

Where the construction panels possess an uneven outer surface, for example an OSB or Waferboard construction panel, it may be necessary to subject the construction panel to an optional sanding step (calibration sanding step and/or finishing sanding step) on its outer surface to generate a uniform outer surface (e.g. top surface). The sanding step removes protruding parts on the outer surface and ensures that the thickness of the construction panel is uniform before entering heating zone (7). This sanding step may involve conveying the construction panels into a calibration sander (8) where parts of the top surface of the construction panel are removed to create a construction panel with a uniform top surface. The calibration sander (8) typically has a grit size of 80 but can vary depending on the construction panel material. After calibration sanding, the panel may optionally be conveyed to a finishing sander (9), where the uniform top surface is processed further to produce a smooth finish. The finishing sander (9) has a grit size which can vary depending on the construction panel material. The construction panels are then conveyed through a brush roller (not shown) which cleans the surface of the panels. The brush roller is also fitted with an extraction system to remove any dust on the panel surface. The dust is removed and taken away via an extraction pipe.

Optionally, in some embodiments, a carrier layer (e.g. paper sheet) may be applied to the uniform outer surface (e.g. top surface) of the construction panel before the construction panels are conveyed to the heater roller coater (10). Adhesive composition may then applied to the surface of the carrier layer by the heater roller coater (10).

The construction panels are then automatically conveyed from, governor roller (6) where no sanding step has been performed, or from finishing sander (9) where a sanding step has been performed, to a radiant gas heater at heating zone (7) where the surface of the construction panels is heated to approximately 45° C. From the heating zone (7), the construction panels are then fed into a heater roller coater (10), where an adhesive composition is applied to the top surface of the construction panels at an application temperature of 100° C. to 150° C. During the step of applying the adhesive composition via heater roller coater (10), a layer of adhesive composition is formed on the top surface of the construction panel. In the embodiment illustrated in FIG. 1, the adhesive composition is a polyurethane hot melt adhesive (e.g. Abrabond Apollo A1024) and the melting tanks are operated at 150° C. to ensure that an appropriate level of viscosity is maintained within the adhesive composition during the step of applying the adhesive composition.

Where the adhesive composition is a hot melt adhesive, heated hoses (11) are also used to supply the heater roller coater (10) with the adhesive composition from adhesive melting tanks (12-15). In some embodiments, two heater roller coaters (10) are operated side-by-side to increase panel throughput.

The layer of adhesive composition includes, formed within its top surface, a surface pattern comprising a plurality of protrusions. This is exemplified in FIG. 2 and labelled with the notation SP as further described below. This surface pattern is integrally formed within the top surface of the adhesive composition layer without any slip resistant additives (e.g. aggregate, grit or particulate matter) necessarily being required to form the plurality of protrusions in the surface pattern. It is therefore the integrally formed surface pattern which provides the final construction panel with the slip resistant properties on its top surface. The surface pattern may be formed via a pull-off effect which occurs between the surface of an application roller, forming part of the heater roller coater (10), and the adhesive composition whilst the layer of adhesive composition is being formed on the top surface of the construction panel. This pull-off effect is discussed in more detail with reference to the exemplary heater roller system described in FIG. 2 below. It will also be appreciated that the surface pattern may be formed within the top surface of the adhesive composition layer due to the presence of a pattern cut into the surface of the application roller. During use, this patterned application roller embosses, prints or presses the surface pattern into the top surface of the adhesive composition layer as the adhesive composition is applied to the construction panel.

The construction panels are then automatically conveyed from the heater roller coater (10) to a cooling/resting area (12) where the layer of hot melt adhesive composition including the surface pattern is allowed to solidify for 24 hours to 48 hours via cooling. This allows for the surface pattern to harden and the hot melt adhesive composition to bond to the top surface of the construction panel.

The construction panels are then conveyed to inspection table (13) to an outfeed nip roller which directs the construction panels to an outfeed pick and place stacking system where the panels are restacked on to outfeed conveyors in either single stack or multiple stack arrangements.

The stacks are then then conveyed from the outfeed conveyor to a packing station, preferably via a forklift truck, where the packs are repackaged into their original/alternative packaging.

FIG. 2 illustrates an example of the heater roller coater (10) as described above. The heater roller coater is made up of a silicon rubber application roller (A) and steel dosing roller (B) which are both heated via an electric element that goes through the centre of each of the rollers. Each roller may be independently heated at a temperature ranging from about 40° C. to about 180° C. depending on the type of adhesive being applied. Typically, where polyurethane hot melt adhesives are used (e.g. Abrabond Apollo A1024), the steel dosing roller (B) is heated to 150° C. and the silicon rubber application roller (A) is heated to 50° C.

A gap (G) between the rollers (i.e. the distance between the silicon rubber application roller (A) and the steel dosing roller (B)) is adjusted to control the coat weight of the adhesive composition being applied to the surface of the construction panel. Typically, gaps having measurements of from about 0 mm to about 3 mm are used but, generally, a heavy coat weight can be achieved by using a larger gap as compared to a lighter coat weight. Typical coat weights that can be achieved by the heater roller coater (10) range from about 20 to about 180 grams per square metre depending on the type of adhesive composition being used.

In use, an adhesive composition is pumped onto and into the space between the silicon rubber application roller (A) and the steel dosing roller (B). The adhesive composition is retained and prevented from spilling from the sides of the rollers by two pneumatic Teflon™ side plates (not shown) situated at each end of the rollers to create a well. The steel dosing roller (B) rotates in the opposite direction to the silicon rubber application roller (A) to force the adhesive composition between the rollers, down the well, through the gap (G) between the rollers and onto the surface of a construction panel (P) located beneath. As the machine bed, shown by (3) in FIG. 1, moves the panel (P) along the production line (in the direction of the arrow shown in FIG. 2) the adhesive composition is applied to the top surface of the panel (P) via the silicon rubber application roller (A) to form a layer of adhesive composition, at a coat weight corresponding to the gap (G) between the rollers.

As mentioned above in relation to FIG. 1, as the layer of adhesive composition is applied to the top surface of the construction panel (P), a surface pattern (SP) comprising a plurality of protrusions is provided within the top surface of the layer of adhesive composition. This surface pattern (SP) is integrally formed and shaped from the adhesive composition material itself and, in the embodiment illustrated in FIG. 2, is not attributed to the presence of any additive materials (e.g. aggregate, grit or particulate matter) which may provide the finished construction panels with a slip resistant surface.

Without being bound by theory, the surface pattern may be formed via a pull-off effect which occurs between the surface of the application roller (A) (typically an application roller with a silicone rubber surface), forming part of the heater roller coater (10), and the adhesive composition whilst the layer of adhesive composition is being formed on the top surface of the construction panel. Here, as illustrated in FIG. 2, the construction panel (P) passes underneath the heater roller coater (10) and provides a substrate support on which the layer of adhesive composition can be formed. Initially, as the construction panel passes the application roller (A), the adhesive composition present on the application roller (A) contacts the top surface of the construction panel. As the construction panel (P) continues to move past the application roller (A), the adhesive composition which is in contact with both the panel surface and the application roller (A) undergoes adhesive failure. This adhesive failure results in the adhesive composition located between the surface of the application roller (A) and the construction panel (P) pulling-off and away from the application roller (A). This causes a surface pattern to be created on the top surface of the layer of adhesive composition as the layer is formed. The surface pattern includes regions where the adhesive composition is vertically heightened or raised to form a plurality of protrusions. The height of the protrusions is depicted in FIG. 6 and labelled (H). Once solidified, the surface pattern provides the layer of adhesive composition with a slip resistant finish.

It will be appreciated by the skilled person that characteristics of the surface pattern (SP) may be modified by controlling various adhesive material and application parameters. For example, adhesive composition coat weights, adhesive composition viscosity and line speed can be varied to modify the frequency and height of the plurality of protrusions integrally formed in the surface pattern (SP).

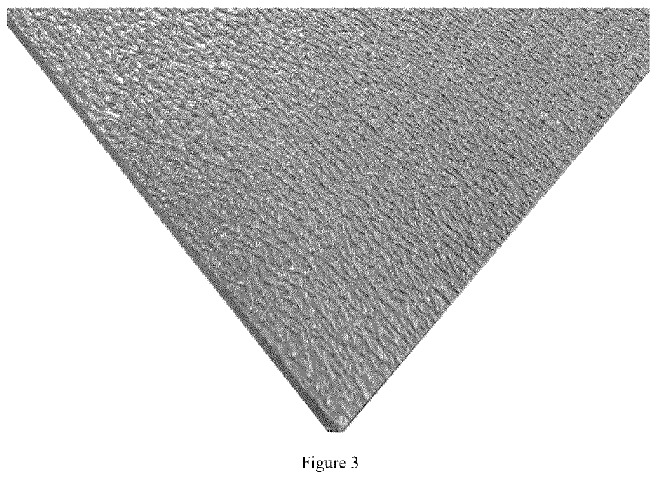

FIG. 3 shows an image of an exemplary slip resistant construction panel comprising a surface pattern which has been prepared using a method and apparatus described herein with reference to FIGS. 1 and 2. Specific method conditions and parameters used to produce the panel illustrated in FIG. 3 are provided in Table 1 below.

TABLE 2

| Construction panel | Chipboard manufactured to BSEN312 | |
|---|---|---|
| Adhesive composition | Abrabond Apollo A1024 (polyurethane hot melt | |
| | coating base) | |
| Adhesive composition viscosity | Approximately. 10,000 cPs @120° C. | |
| Adhesive composition colour | Grey | |
| Adhesive composition coat | 120-140 grams per square metre (g/m²) | |
| weight | | |
| Adhesive composition | 150° | C. |
| application temperature | | |
| Construction panel cooling time | 48 | hours |

| | |
|---|---|
| Line speed at heater roller coater | 13 metres per minute (m/m) |
| Application roller surface | Flat/smooth - silicon rubber |
| Surface pattern formed on | Irregular rippled surface pattern. Ripples occur |
| construction panel | every 0.5 mm to 1 mm across the construction |
| | panel and have a ripple protrusion height of |
| | approx. 0.5 mm. |
| Average Pendulum Test Value | 56 |
| (PTV) (dry) | |
| Average Pendulum Test Value | 47 |
| (PTV) (wet) | |

### Slip Resistance Test Method

The construction panel shown in the image of FIG. 3, also produced using the method parameters detailed in Table 2, was tested for its slip resistant properties using the Pendulum test method in accordance with the British Standard BS 7976. Pendulum Test Values (PTV) were measured under both wet and dry conditions.

The Pendulum test methodology (BS 7976) is a well-developed test method and gives an indication of the likelihood of a person slipping whilst walking on a flooring material (e.g. floor construction panel). A pendulum is attached to a spring loaded foot fitted with a standard rubber slider (Slider 96 which meets the requirements of BS 7976). The pendulum is allowed to swing so that the slider contacts the patterned surface of the construction panel. The test is performed with the slider located at a set distance and predetermined release height. The extent to which the pendulum fails to reach its release height on its overswing is determined as a measurement of the slip resistance of the construction panel surface pattern. The slip resistance is measured using a physical scale and pointer. The pointer follows the pendulum arm overswing and can be measured by reading the overswing distance, as compared to the predetermined release height, using the physical scale. This measurement value obtained is called a Pendulum Test Value (PTV). The test is carried out starting from three pendulum positions, horizontal, vertical (at 90° to the horizontal) and diagonal (at 45° to the horizontal). The test is also carried out under wet as well as dry conditions to provide PTV values in wet and dry conditions. The test is performed from each pendulum position 5 times under both wet and dry conditions. Averages are then taken to provide average dry and wet PTV values.

The UK Slip Resistance Group provides the following guidelines:

| PTV value | Slip potential |
|---|---|
| 0-24 | High |
| 25-35 | Moderate |
| 36+ | Low |

As it can be seen in Table 2, the slip resistance construction panel shown in the image of FIG. 3, results in excellent slip resistant properties being measured for the surface patterned side of the construction panel. The average PTV measurements under both wet and dry conditions confirm that the slip potential is low. Standard chipboard based construction panels protected and sealed with UV lacquers generally possess PTV (wet) values of less than 24 representing a high slip potential risk.

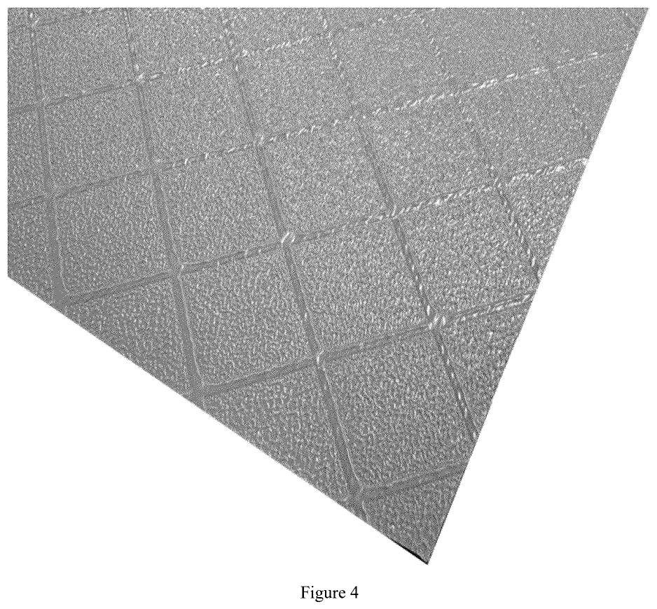

FIG. 4 shows an image of an exemplary slip resistant construction panel comprising a diamond-square shaped surface pattern which has been prepared using an analogous method and apparatus to that described herein with reference to FIGS. 1-2 and Table 2. The heater roller coater used to produce the panel in FIG. 4, however, includes an application roller possessing a diamond-square pattern cut into its surface. The repeat diamond-squares have dimensions of 30 mm×30 mm. It will be appreciated that, as the adhesive composition is applied to the top surface of the construction panel, the layer of adhesive composition is formed having an embossed diamond-square pattern integrally formed within its top surface. As shown in FIG. 4, the surface pattern also includes sections of an irregular rippled surface pattern residing within the diamond-squares. This irregular rippled surface pattern occurs due to the pull-off effect described herein.

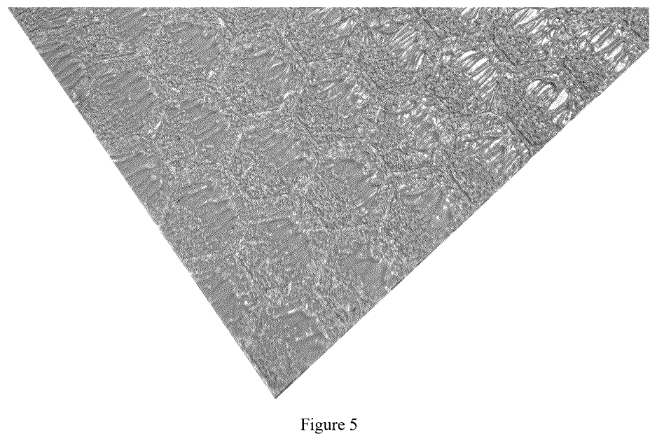

FIG. 5 shows an image of an exemplary slip resistant construction panel comprising a hexagonal surface pattern which has been prepared using an analogous method and apparatus to that described herein with reference to FIGS. 1-2 and Table 2. The heater roller coater used to produce the panel in FIG. 5, however, includes an application roller possessing a hexagonal pattern cut into its surface. The repeat hexagons have dimensions of 10 mm for each of its six sides with a 4 mm border between each hexagon. It will be appreciated that, whilst applying the adhesive composition to the top surface of the construction panel, the layer of adhesive composition is formed having an embossed hexagonal pattern integrally formed within its top surface. As shown in FIG. 5, the surface pattern includes sections of an irregular rippled surface pattern residing within the hexagons. This irregular rippled surface pattern occurs due to the pull-off effect described herein.

It will be appreciated by the skilled person that by vary the method parameters/conditions and the type of pattern cut into the surface of the application roller it is possible to modify the properties of the embossed surface pattern integrally formed on the construction panel. It will also appreciated that in some embodiments of the present invention slip resistant construction panels can be formed using patterned application rollers only, without the need for the pull off effect described above occurring.

It will also be appreciated that the methods, materials and equipment/machinery described in relation to FIGS. 1-6 above, may be suitably modified by the skilled person to carry out a method according to the present invention.

What is claimed is:

1. A method of preparing a substrate comprising a slip resistant surface, the method comprising:
applying a viscous composition to a surface of a substrate to form a layer of viscous composition on the surface of the substrate, wherein the layer of viscous composition has an adhering surface which is in contact with the surface of the substrate and an opposing surface facing away from the surface of the substrate;
forming a surface pattern comprising a plurality of protrusions within the opposing surface; and
solidifying the layer of viscous composition to (i) provide the slip resistant surface from the surface pattern; and (ii) bond the adhering surface to the surface of the substrate.

2. The method of claim 1, wherein the substrate is a construction panel.

3. The method of claim 1, wherein the viscous composition has a viscosity of about 5000 cPs @ 120° C. to about 15,000 cPs @ 120° C.

4. The method of claim 1, wherein the viscous composition is an adhesive composition.

5. The method of claim 4, wherein the adhesive composition is selected from the group consisting of a hot melt adhesive, a photo sensitive adhesive, a drying adhesive and combination thereof.

6. The method of claim 5, wherein the adhesive composition is the hot melt adhesive.

7. The method of claim 4, wherein applying the adhesive composition to the surface of the substrate is performed at an application temperature of about 80° C. to about 180° C.

8. The method of claim 1, wherein applying the viscous composition comprises application of the viscous composition at coat weight of about 80 grams per square metre (g/m²) to about 180 grams per square metre (g/m²).

9. The method of claim 1, wherein solidifying the layer of viscous composition comprises reducing a temperature of the viscous composition.

10. The method of claim 9, wherein reducing the temperature is performed from about 1 hour to about 72 hours.

11. The method of claim 1, wherein (i) applying the viscous composition to the surface of the substrate and forming the surface pattern occur concurrently; or (ii) forming the surface pattern is performed subsequent to applying the viscous composition to the surface of the substrate.

12. The method of claim 1, wherein applying the viscous composition to the surface of the substrate and forming the surface pattern comprises using a roller coater.

13. The method of claim 12, wherein forming the surface pattern occurs whilst applying the viscous composition to a surface of the substrate due to the viscous composition undergoing pull-off from a surface of the roller coater.

14. The method of claim 13, wherein applying the viscous composition to the surface of the substrate and forming the surface pattern comprises using the roller coater at a line speed of from about 3 metres per minute (m/m) to about 20 metres per minute (m/m).

15. The method of claim 13, wherein the surface of the roller coater comprises an embossed pattern.

16. The method of claim 2, wherein the construction panel is made of a wood-based material.

17. The method of claim 16, wherein the wood-based material is selected from the group consisting of plywood, oriented strand board (OSB), waferboard, medium density fibreboard (MDF), timber-board, chipboard, hardboard and combination thereof.

18. A slip resistant substrate comprising a slip resistant surface obtained or obtainable by claim 1.

19. A slip resistant substrate comprising:
a substrate layer comprising a substrate surface;
a solidified viscous composition layer comprising an adhering surface bonded to the substrate surface and an opposing surface facing away from the substrate surface; and
a surface pattern comprising a plurality of protrusions formed within the opposing surface to provide a slip resistant surface.

20. The substrate of claim 19, wherein the substrate is a construction panel.
